(19) United States
(12) Patent Application Publication
(10) Pub. No.: US 2019/0204842 A1
(43) Pub. Date: Jul. 4, 2019

(54) TRAJECTORY PLANNER WITH DYNAMIC COST LEARNING FOR AUTONOMOUS DRIVING

(71) Applicant: GM Global Technology Operations LLC, Detroit, MI (US)

(72) Inventors: Sayyed Rouhollah Jafari Tafti, Troy, MI (US); Guangyu J. Zou, Warren, MI (US); Marcus J. Huber, Saline, MI (US); Upali P. Mudalige, Oakland Township, MI (US)

(21) Appl. No.: 15/859,857

(22) Filed: Jan. 2, 2018

(51) Int. Cl. G05D 1/02; G05D 1/00; G06N 3/08; G06N 3/04

(52) U.S. Cl. CPC G05D 1/0221; G06N 3/04; G06N 3/08; G05D 1/0088

(57) ABSTRACT

A vehicle, system and method of autonomous navigation of the vehicle. A reference trajectory for navigating a training traffic scenario along a road section is received at a processor of the vehicle. The processor determines a coefficient for a cost function associated with a candidate trajectory that simulates the reference trajectory. The determined coefficient is provided to a neural network to train the neural network. The trained neural network generates a navigation trajectory for navigating the vehicle using a cost coefficient determined by the neural network. The vehicle is navigated along the road section using the navigation trajectory.

### INTRODUCTION

The subject disclosure relates to systems for autonomous navigation of a vehicle and in particular to systems and methods for training a neural network to select a trajectory for navigation in dynamic road and traffic scenarios.

Autonomous vehicles employ motion planning systems that generate trajectories for navigating the vehicle. Most motion planning systems find an optimal trajectory for a vehicle over a section of road by determining cost functions associated with the trajectory. However, it is often difficult to generate a trajectory that emulates human-like driving while being operable over a plurality of different road scenarios using only a single or even multiple cost functions. Accordingly, it is desirable to provide an approach to trajectory planning that learns optimal trajectories dynamically for different road scenarios.

### SUMMARY

In one exemplary embodiment, a method of autonomous navigation of a vehicle is disclosed. The method includes receiving, at a processor, a reference trajectory for navigating a training traffic scenario along a road section, determining, at the processor, a coefficient for a cost function associated with a candidate trajectory that simulates the reference trajectory, providing the determined coefficient to a neural network to train the neural network, and generating, using the trained neural network, a navigation trajectory for navigating the vehicle using a proper cost coefficient determined by the neural network. The vehicle is navigated along the road section using the navigation trajectory.

In addition to one or more of the features described herein, the road section is represented by a search graph that is used to train the neural network, and the candidate trajectory is confined to the search graph. The search graph can include vehicle state data and data for objects along the road section. The cost function associated with the candidate trajectory is dependent on objects in the training traffic scenario.

Determining the coefficient includes determining a cost associated with the reference trajectory and determining the coefficient for which the cost function associated with the candidate trajectory outputs a cost that is within a selected criterion of the cost associated with the reference trajectory. In various embodiments, the coefficient of the cost function are selected to provide a minimum-cost optimal trajectory that approximates the reference trajectory.

In another exemplary embodiment, a system for navigating an autonomous vehicle is disclosed. The system includes a processor that is configured to receive a reference trajectory for navigating a training traffic scenario along a road section, determine a coefficient for a cost function associated with a candidate trajectory that simulates the reference trajectory, provide the determined coefficient to a neural network to train the neural network, and generate, at the neural network, a navigation trajectory for navigating the vehicle using a proper cost coefficient determined by the neural network. The processor is further configured to navigate the vehicle along the road section using the navigation trajectory.

In addition to one or more of the features described herein, the processor is further configured to represent the road section via a search graph with the candidate trajectory confined to the search graph and to train the neural network using the search graph as an input. The search graph includes vehicle state data and data for objects along the road section. The cost function associated with the candidate trajectory is dependent on objects in the traffic scenario.

The processor is further configured to determine the coefficient for which the cost associated with the candidate trajectory is within a selected criterion of a cost associated with the reference trajectory. The processor is further configured to determine the coefficients of the cost function which provides a minimum-cost optimal trajectory that approximates the reference trajectory and to train the neural network using the determined coefficients.

In yet another exemplary embodiment, an autonomous vehicle is disclosed. The vehicle includes a processor configured to receive a reference trajectory for navigating a training traffic scenario along a road section, determine a coefficient for a cost associated with a candidate trajectory that simulates the reference trajectory, provide the determined coefficient to a neural network to train the neural network, generate a navigation trajectory for navigating the vehicle using proper cost coefficients determined by the trained neural network, and navigate the vehicle along the road section using the navigation trajectory.

In addition to one or more of the features described herein, the processor represents the road section via a search graph with the candidate trajectory confined to the search graph and to train the neural network using the search graph. The cost function associated with the candidate trajectory is dependent on objects in the traffic scenario. The processor determines the coefficient for which the cost associated with the candidate trajectory is within a selected criterion of a cost associated with the reference trajectory. The processor determines the coefficients of the cost function which provides a minimum-cost optimal trajectory that approximates the reference trajectory and train the neural network using the determined coefficients.

The vehicle includes a sensor that detects a condition of the vehicle and of a real-time traffic scenario involving the vehicle, and the neural network generates cost coefficients suitable for the sensed real-time traffic scenario and generates the navigation trajectory from the generated cost coefficients.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a trajectory planning system generally associated with a vehicle in accordance with various embodiments;

FIG. 2 shows a top view of an illustrative traffic scenario that can be encountered by a host vehicle or can be used as a training scenario;

FIG. 3 shows a schematic diagram illustrating a data flow for finding the cost function coefficients used for training a Deep Neural Network (DNN) in one embodiment;

FIG. 4 shows a schematic diagram for training the DNN to a selected traffic scenario in an embodiment;

FIG. 5 shows a schematic diagram of a data flow for using a trained neural network in operation of a vehicle in order to navigate a traffic pattern in one embodiment; and

FIG. 6 shows flowchart illustrating a method of navigating a selected traffic scenario according to one embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

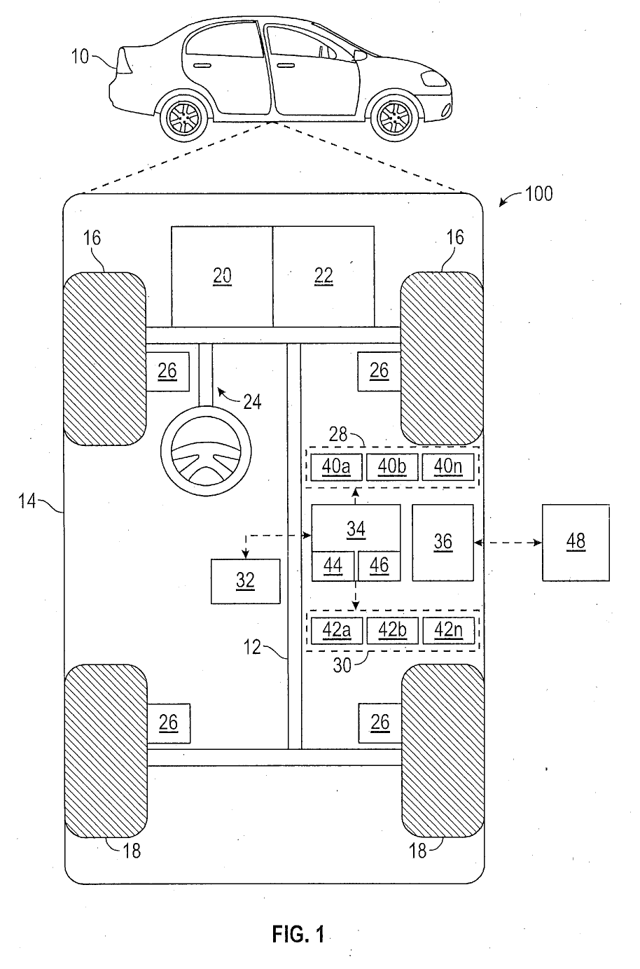

With reference to FIG. 1, a trajectory planning system shown generally at 100 is associated with an autonomous vehicle 10 in accordance with various embodiments. In general, system 100 determines a trajectory plan for automated driving. As depicted in FIG. 1, the autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a uni-body structure. The wheels 16-18 are each rotationally coupled to the chassis 12 near a respective corner of the body 14.

In various embodiments, the autonomous vehicle 10 is an autonomous vehicle and the trajectory planning system 100 is incorporated into the autonomous vehicle 10 (hereinafter referred to as the autonomous vehicle 10). The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

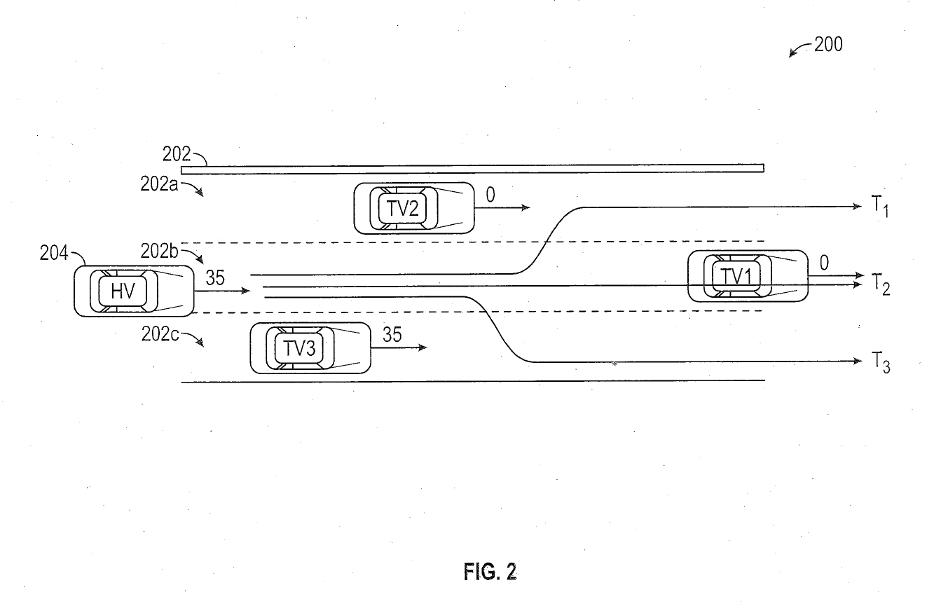

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the trajectory planning system 100 and, when executed by the processor 44, generates a trajectory output that addresses kinematic and dynamic constraints of the environment. For example, the instructions receive process signals and map data as input. The instructions perform a graph-based approach with a customized cost function to handle different road scenarios in both urban and highway roads.

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The autonomous vehicle 10 includes a system for autonomous navigation through a selected road scenario or a selected traffic scenario over a road section. The system operates and trains a neural network to drive with respect to a plurality of traffic scenarios, road scenarios, etc., and then uses the trained neural network to drive in actual road and traffic scenarios. The training method includes collecting training data for a desired human-like driving in different road scenarios and generating a search graph based on inputs to a trajectory planning system 100. A cost function is defined for the search graph which defines the cost value for each trajectory to traverse the search graph from a starting point of the search graph to an ending point of the search graph. The cost function includes different cost components which are pre-defined and different cost coefficients which specify the weights for each cost component. A cost component can be an assigned or calculated energy cost or energy expense of the vehicle for a having collision with other objects on the road, or an assigned or calculated energy cost or energy expense for steering, switching lanes, changing speed, etc. A desired trajectory of the vehicle in collected training data is then used to find the corresponding cost function coefficients that result in a minimum-cost trajectory or substantially minimum-cost trajectory which is close to the desired trajectory as determined through the graph search. The values of the coefficients can then be stored in a database and used for training the deep neural network. In an actual driving situations, the system can recognize an actual traffic scenario that matches or substantially matches the training traffic scenario and calculates the proper coefficients to construct a trajectory for detected traffic scenario and navigate the vehicle along the constructed trajectory.

FIG. 2 shows a top view 200 of an illustrative traffic scenario that can be encountered by a host vehicle or can be used as a training scenario. The top view 200 shows a host vehicle (HV) 204 driving along a center lane of a three-lane road 202 at 35 kilometers per hour (km/h). The three-lane road 202 includes a left lane 202a, the central lane 202b, and a right lane 202c. The HV 204 is at a left-most side of the page. Several remote objects are also on the road 202 and provide obstacles for the host vehicle 204 to reach its destination, e.g., the right-most side of the page. In particular, target vehicle 1 (TV1) is in the center lane 202b and is traveling at zero km/h (stationary), target vehicle 2 (TV2) is in the left land 202a and is traveling at zero km/h (stationary), and target vehicle 3 (TV3) is in the right lane 202c and is traveling at 35 km/h.

HV 204 can consider various trajectories (T1, T2, T3) in order to navigate the three-lane road 202. However, the selection of which trajectory to take depends on traffic conditions and a cost or expense associated with the trajectory for the given traffic condition. A cost or energy expense associated with a trajectory can be based on several elements, such as road conditions, traffic conditions, etc. For example, an energy expense may be incurred by changing lanes, or by the need to steer the vehicle. Additionally, an energy expense may be incurred by continuing along a trajectory that brings the host vehicle 204 into contact with any target vehicle or that drives the vehicle off the road.

For illustration, consider first a traffic scenario in which HV 204 is the only vehicle on the road. HV 204 is most likely to select trajectory T2 (driving along the center lane 202b without changing lanes) as this invokes a relatively low cost to the controller of the HV 104, as there is no need to change lanes, etc. Trajectory T1 includes changing to the left lane 202b and incurs a cost as a result of changing lanes. Trajectory T3 includes changing to the right lane 2023 and incurs a cost as a result of changing lanes. Thus, trajectory T2 has the lowest cost and is therefore the trajectory that is selected.

Consider now the traffic scenario specifically shown in FIG. 2, which includes vehicles TV1, TV2 and TV3. By driving along trajectory T2, HV 204 drives along the center lane 202b until it runs into TV1, which is an undesirable outcome. Cost calculations are such that a high cost is associated with collision, in some cases, the cost for collision may be set as infinite. Therefore a high cost is associated with trajectory T2. On the other hand, by driving along the trajectory T1, HV 204 can drive along the center lane 202b in order to pass up TV2, change into the left lane 202a and then drive past TV1, thereby successfully navigating through the traffic. Although cost is incurred by changing lanes, any acceleration, deceleration, etc., there is no cost incurred by collision. Therefore, the cost associated with trajectory T1 is relatively low. Trajectory T3 appears to be an unachievable trajectory because HV 104 and TV3 are driving at the same velocity, preventing HV 204 from passing up TV3 in order to change into the right lane 202c in front of TV3. Thus, a high cost may also be associated with trajectory T3. Comparison of trajectory costs causes one to select trajectory T1 for this scenario.

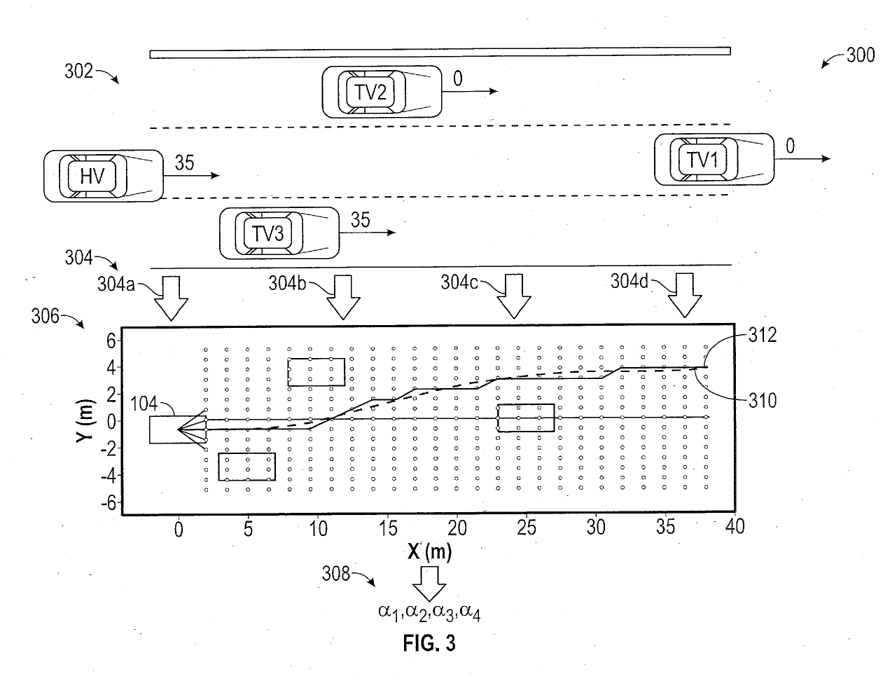

FIG. 3 shows a schematic diagram 300 illustrating a data flow for training a neural network in one embodiment. The diagram 300 involves a training scenario that is used to train the neural network. It is to be understood that a plurality of training scenarios must be used to train for multiple possible road or traffic scenarios. The training scenarios can differ by a number, location and velocity of target vehicles, road conditions, road curvature, as well as different states of the host vehicle.

The training scenario provides inputs to the trajectory planning system 100 in the form of data 304, such as state data 304a, road scenario data 304b, behavior data 304c and object fusion data 304d. State data 304a (“HV states”) include parameters of the host vehicle such as position, velocity, orientation, acceleration, etc. of the host vehicle. Road scenario data 304b provide information concerning the road section boundaries and geometry, including length, width, number of lanes, curvature, etc., as well as a default trajectory. Behavior data 304c provide dynamic guidance of the host vehicle, such as the kinematic ability of the host vehicle to speed up, slow down, turn left, turn right, change into a left lane, change into a right lane, etc. Object fusion data 304d include, for example, the number, locations, and speeds of the target vehicles (TV1, TV2, TV3).

A search graph 306 is formed using the state data 304a, road scenario data 304b and behavior data 304c as a grid representation including different trajectories for the host vehicle 104 to traverse the traffic scenario. The search graph 306 is created without considering the presence of target vehicles or other objects. Grid locations indicate possible locations for the host vehicle as it moves along the road from a starting location of the grid (generally on the left) to an end location of the grid (generally on the right). A cost is incurred as the host vehicle moves along grid points. Each movement between grid points has an associated cost and the cost for a trajectory along the grid is the summation of the costs for each movement along the grid points that make up the trajectory. Target vehicles can then be added to search graph so that the location and velocity of target vehicles are involved in determining the costs of these trajectories.

Once the search graph 306 is calculated, a reference trajectory 310 of the host vehicle 104 which was collected during a desired human-like driving or a computer simulated driving for navigating through the traffic scenario is provided. The reference trajectory 310 is superimposed over the search graph 306 and an optimal trajectory 312 in the search graph 306 which is closest to the reference trajectory 310 is found. Cost function coefficients 308 which specify the weights for each cost component are then determined such that searching the graph 306 with that cost function results in the optimal trajectory 312 with minimum cost value among all candidate trajectories in the search graph 306. Training the neural network is implemented by using the search graph 306 and cost coefficients 308.

In an embodiment, the cost function to find an optimal trajectory 312 in the search graph 306 is defined, where the relation between cost function and cost components is represented in Eq. (1):

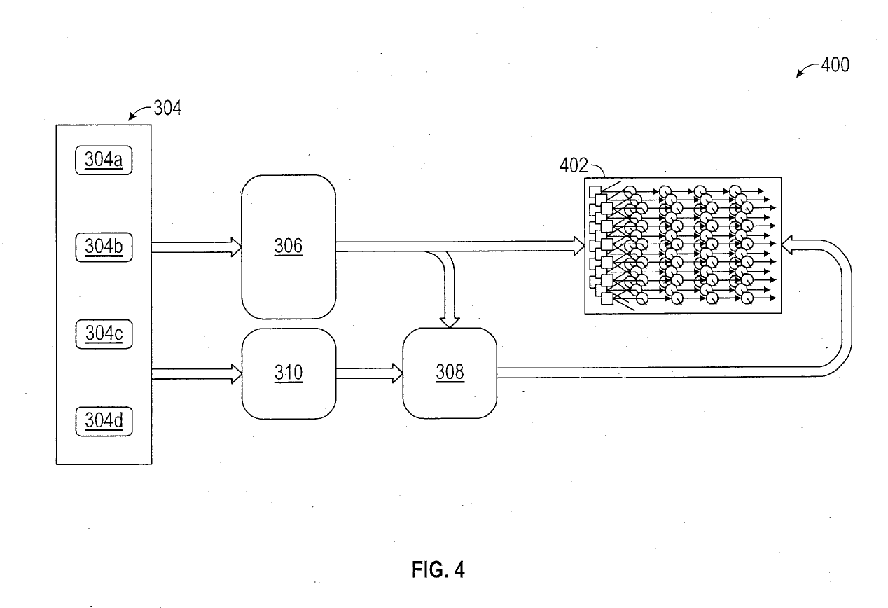

C_{trajectory}=Σᵢ∝ᵢCᵢ (1)

where C_{trajectory} is the cost function associated with each candidate trajectory, Cᵢ is a cost component that indicates a cost associated with a trajectory and αᵢ is a coefficient associated with the i^{th} cost component. The coefficients αᵢ are included to determine the weight of each cost component in the overall cost of each candidate trajectory. The deep neural network is trained to learn these coefficients αᵢ for different road scenarios and traffic conditions. FIG. 4 shows a schematic diagram 400 for training of a deep neural network to a selected traffic scenario, in an embodiment. Log data 304 is provided, such as vehicle state data 304a, road scenario data 304b, behavior data 304c and object fusion data 304d. The log data are used to generate a search graph 306. The logged vehicle state data 304a can be used to determine a driven reference trajectory 310 for the vehicle. The search graph 306 and the reference trajectory 310 then are used to determine the cost coefficients 308. The search graph 306 and the cost coefficients 308 are then provided to the deep neural network 402 in order to train the neural network 402 for the selected traffic scenario.

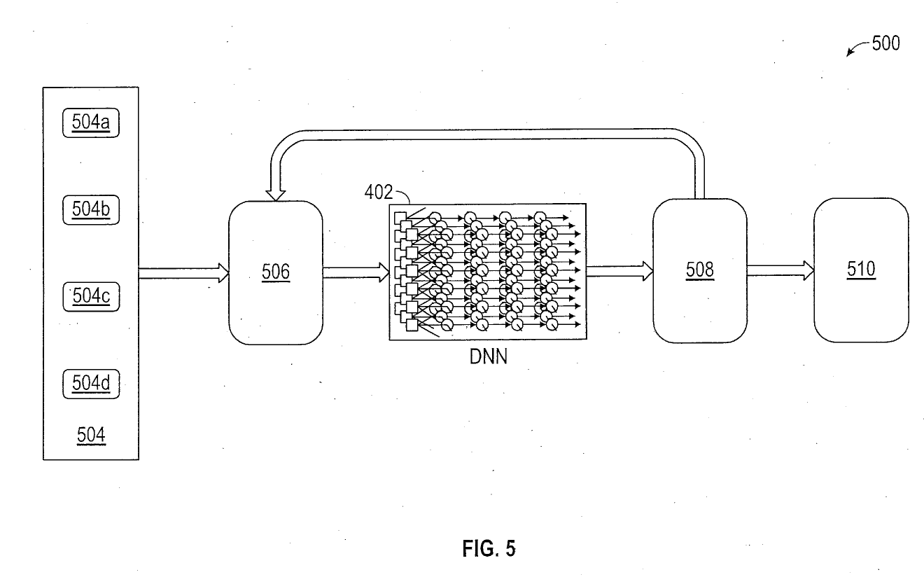

FIG. 5 shows a schematic diagram 500 of a data flow for using a trained neural network in operation of a vehicle in order to navigate a traffic pattern in one embodiment. The vehicle senses various data 504 such as vehicle state data 504a, road scenario data 504b, behavior data 504c and object fusion data 504d as the vehicle is in a traffic scenario using sensors on the host vehicle. These parameters 504 are provided to form a search graph 506. The search graph 506 is provided to the trained deep neural network 402 which outputs the proper cost function coefficients 508. These cost coefficients are used to search the graph 506 in order to find the optimal minimum-cost trajectory 508. The optimal trajectory 508 is then used to determine a safe and smooth final trajectory 510 that satisfies the kinematic constraints of the host vehicle. The final trajectory 510 is then provided to the controller in order to navigate the vehicle through the current road scenario.

Thus, navigating the vehicle includes a training scenario includes a processor receives a training traffic scenario as well as a reference trajectory suitable for navigating the training traffic scenario. The processor determines multiple coefficients associated with a cost function. The coefficients are determined in a way that result in an optimal minimum-cost trajectory through searching the graph which matches or is close to the reference trajectory. The determined coefficient and search graphs, as well as various parameters that parametrize the search graph, such as the kinematics of the vehicle and objects along the road section, are provided to a deep neural network to train the neural network. The trained neural network is then used to generate a navigation trajectory for real-time traffic scenarios. A sensor can detect a real-time traffic scenario, generate coefficients suitable for the real-time traffic scenario and generate the navigation trajectory from the generated cost coefficients.

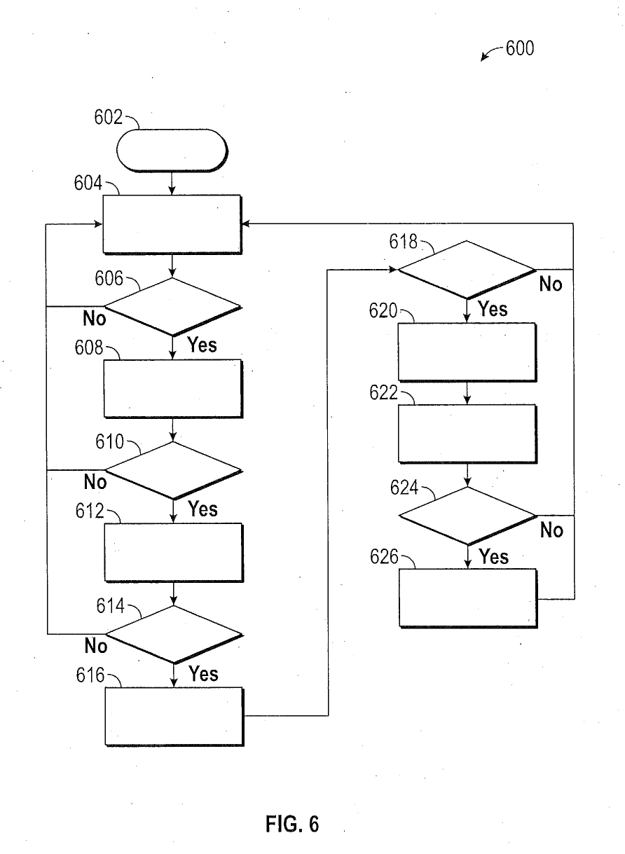

FIG. 6 shows flowchart 600 illustrating a method of navigating a selected traffic scenario according to one embodiment. The method starts at box 602 and proceeds to box 604 at which sensors on the vehicle are used to obtain inputs such as environmental conditions of the vehicle, such as the road parameters and traffic scenarios, such as the location of the foreign objects and vehicles, their range, azimuth and relative speed. In box 606, the processor checks the inputs to determine whether they are valid. If the inputs are not valid, the process returns to box 604 obtain new inputs. When the inputs are considered valid, the method proceeds to box 608. In box 608 a search graph is generated. In box 610, the method determines if the search graph is a valid search graph. If the search graph is not valid, the method returns to obtaining inputs in box 604. If the search graph is valid, the method proceeds to box 612, in which the neural network calculates cost function coefficients. In box 614, the method determines whether coefficients are valid or not. If the coefficients are not valid, the method returns to box 604 to obtain new inputs. If the coefficients are valid, the method proceeds to box 616. In box 616, the graph is searched in order to find an optimal path. In box 618, it is determined whether or not the optimal path is valid. If the optimal path is not valid, the method returns to box 604 in order to obtain new inputs. If the optimal path is valid, the method proceeds to box 620. In box 620, the optimal path is smoothed in order to form a smoothed trajectory over the road.

The smoothed trajectory is a path within a safe corridor with minimal curvature and curvature rate. The smoothed trajectory avoids, among other things, excessive lateral acceleration or jerking during driving. In box 622, the method generates a local trajectory from the smoothed trajectory. Local trajectory differs from the smoothed trajectory in that it satisfies kinematic constraints such as continuity in position, heading, curvature and velocity for the host vehicle. In box 624, it is determined whether the local trajectory is safe and feasible or not. If it is determined that the local trajectory is not safe or not feasible, the method returns to box 604. If it is determined that the local trajectory is safe and feasible, the trajectory is sent to controller in box 626 in order to navigate the vehicle using the local trajectory.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A method of autonomous navigation of a vehicle, comprising:
receiving, at a processor, a reference trajectory for navigating a training traffic scenario along a road section;
determining, at the processor, a coefficient for a cost function associated with a candidate trajectory that simulates the reference trajectory;
providing the determined coefficient to a neural network to train the neural network; and
generating, using the trained neural network, a navigation trajectory for navigating the vehicle using a proper cost coefficient determined by the neural network.

2. The method of claim 1, further comprising navigating the vehicle along the road section using the navigation trajectory.

3. The method of claim 1 further comprising representing the road section via a search graph, wherein the candidate trajectory is confined to the search graph, and training the neural network using the search graph.

4. The method of claim 3, wherein the search graph includes vehicle state data and data for objects along the road section.

5. The method of claim 1, wherein the cost function associated with the candidate trajectory is dependent on objects in the traffic scenario.

6. The method of claim 1, wherein determining the coefficient further comprises determining a cost associated with the reference trajectory and determining the coefficient for which the cost function associated with the candidate trajectory outputs a cost that is within a selected criterion of the cost associated with the reference trajectory.

7. The method of claim 1, further comprising determining the coefficient of the cost function that provides a minimum-cost optimal trajectory that approximates the reference trajectory.

8. A system for navigating an autonomous vehicle, comprising:
a processor configured to:
receive a reference trajectory for navigating a training traffic scenario along a road section;
determine a coefficient for a cost function associated with a candidate trajectory that simulates the reference trajectory;
provide the determined coefficient to a neural network to train the neural network; and
generate, at the neural network, a navigation trajectory for navigating the vehicle using a proper cost coefficient determined by the neural network.

9. The system of claim 8, wherein the processor is further configured to navigate the vehicle along the road section using the navigation trajectory.

10. The system of claim 8, wherein the processor is further configured to represent the road section via a search graph with the candidate trajectory confined to the search graph and train the neural network using the search graph as an input.

11. The system of claim 10, wherein the search graph includes vehicle state data and data for objects along the road section.

12. The system of claim 8, wherein the cost function associated with the candidate trajectory is dependent on objects in the training traffic scenario.

13. The system of claim 8, wherein the processor is further configured to determine the coefficient for which the cost associated with the candidate trajectory is within a selected criterion of a cost associated with the reference trajectory.

14. The system of claim 8, wherein the processor is further configured to determine the coefficients of the cost function which provides a minimum-cost optimal trajectory that approximates the reference trajectory and train the neural network using the determined coefficients.

15. An autonomous vehicle, comprising:
a processor configured to:
receive a reference trajectory for navigating a training traffic scenario along a road section;
determine a coefficient for a cost function associated with a candidate trajectory that simulates the reference trajectory;
provide the determined coefficient to a neural network to train the neural network;
generate a navigation trajectory for navigating the vehicle using proper cost coefficients determined by the trained neural network; and
navigate the vehicle along the road section using the navigation trajectory.

16. The vehicle of claim 15, wherein the processor is further configured to represent the road section via a search graph with the candidate trajectory confined to the search graph and to train the neural network using the search graph.

17. The vehicle of claim 15, wherein the cost function associated with the candidate trajectory is dependent on objects in the traffic scenario.

18. The vehicle of claim 15, wherein the processor is further configured to determine the coefficient for which the cost associated with the candidate trajectory is within a selected criterion of a cost associated with the reference trajectory.

19. The vehicle of claim 15, wherein the processor is further configured to determine the coefficients of the cost function which provides a minimum-cost optimal trajectory that approximates the reference trajectory and train the neural network using the determined coefficients.

20. The vehicle of claim 15 further comprising a sensor that detects a condition of the vehicle and of a real-time traffic scenario involving the vehicle, wherein the neural network is further configured to generate cost coefficients suitable for the sensed real-time traffic scenario and generates the navigation trajectory from the generated cost coefficients.
